(19) United States
(12) Patent Application Publication
(10) Pub. No.: US 2014/0219608 A1
(43) Pub. Date: Aug. 7, 2014

(54) OPTICAL POWER SPLITTERS

(71) Applicants: Wayne V Sorin, Mountain View, CA (US); Michael Renne Ty Tan, Menlo Park, CA (US); Sagi Varghese Mathai, Pao Alto, CA (US); Paul Kessler Rosenberg, Sunnyvale, CA (US); Georgios Panotopoulos, Berkeley, CA (US)

(72) Inventors: Wayne V Sorin, Mountain View, CA (US); Michael Renne Ty Tan, Menlo Park, CA (US); Sagi Varghese Mathai, Pao Alto, CA (US); Paul Kessler Rosenberg, Sunnyvale, CA (US); Georgios Panotopoulos, Berkeley, CA (US)

(21) Appl. No.: 14/234,987

(22) PCT Filed: Jul. 29, 2011
(86) PCT No.: PCT/US2011/045866

§ 371 Date: Jan. 24, 2014

(51) Int. Cl. G02B 6/28; G02B 27/14

(52) U.S. Cl. CPC G02B 6/2817; G02B 27/14; G02B 27/141
USPC 385/48; 359/629; 359/634

(57) ABSTRACT

Waveguide array optical power splitters that provide compact, low-cost implementation of optical power splitting for one and two dimensional optical waveguide arrays are disclosed. The optical power splitters do not introduce mode dependent loss and preserve polarization, enabling the optical power splitters to be used with multimode and single mode light sources. In one aspect, an optical power splitter includes a beamsplitter to receive a plurality of incident beams of light. The beamsplitter splits each incident beam of light into a plurality of output beams of light with each output beam output in a different direction from the beamsplitter. The optical power splitter includes a first set of lenses with each lens to approximately collimate one of the incident beams of light, and includes a second set of lenses with each lens to focus the output beams of light.

### BACKGROUND

In recent years, replacement of electronic components with optical components in high performance computer systems has received considerable attention. On the one hand, electronic components can be labor intensive to set up and sending electric signals using conventional wires and pins consumes large amounts of power. In addition, it is becoming increasingly difficult to scale the bandwidth of electronic interconnects, and the relative amount of time needed to send electric signals over an electronic interconnect fabric is too long to take full advantage of the high-speed performance offered by smaller and faster processors. On the other hand, optical components offer a number of advantages over electronic components. For instance, optical fibers have large bandwidths, and optical components, in general, provide low transmission loss, enable data to be transmitted with significantly lower power consumption, are immune to cross talk, and are made of materials that do not undergo corrosion or are affected by external radiation.

Although, optical communication appears to be an attractive alternative to electronic communication, many existing optical components are not suitable for all types of optical communication. For instance, fully-meshed optical point-to-point connectivity between server blades in a blade system appears to be an attractive alternative to an electronic interconnect fabric. However, using conventional optical components to implement such a system requires each blade to have multiple optical transmitters and receivers in combination with high cost optical components, which make fully-meshed optical point-to-point connectivity impractical. In recent years, use of multimode optical fibers with optical power slitting has emerged as a potentially lower-cost alternative to optical point-to-point connectivity. Multimode fibers and optical power splitters are typically used in short-distance systems, including local area networks and data-center interconnects. However, typical optical power splitters introduce mode filtering in the optical signals carried by multimode fibers. For instance, multimode fiber fused couplers evenly split the optical power carried by a single input fiber into multiple output fibers, but the transverse fiber modes are not coupled evenly into each output fiber, resulting in mode dependent loss or differential mode filtering. As a result, manufacturers, designers, and users of large scale computer systems continue to seek lower cost, mode preserving optical components for optical communication.

### BRIEF DESCRIPTION OF THE DRAWINGS

FIG. 1 shows a side elevation view of an example optical power splitter.

FIGS. 2A-2B show cross-sectional views of an example two-dimensional waveguide array and an example one-dimensional waveguide array.

FIGS. 3A-3E show exploded and isometric views of example beamsplitters.

FIGS. 4A-4C show three separate examples of transverse modes of light carried by an optical fiber.

FIG. 5 shows two opposing lenses of an optical power splitter.

FIG. 6 shows a side elevation view of an example optical power splitter.

FIGS. 7A-7B show an example of waveguides in waveguide arrays dedicated to input light to and receive light output from an optical power splitter.

FIG. 8 shows an example of reflected and transmitted paths of light input to an optical power splitter.

FIG. 9 shows an example optical power splitter with a beamsplitter configured to output light into waveguide arrays, each waveguide array receiving light with a different optical power.

FIGS. 10A-10B show an example optical power splitter with a beamsplitter configured to output light into waveguide arrays based on the wavelength of the light.

FIG. 11 shows a side elevation view of an example optical power splitter.

FIG. 12A shows an isometric view of an example rack mounted computer system composed of eight nodes.

FIG. 12B shows a schematic representation of four optical power splitters that form a star optical bus.

FIG. 12C shows an example of four waveguide arrays connected to an optical power splitter of the star optical bus shown in FIG. 12B.

FIGS. 13A-13C shows an example schematic representation and operation of an optical power splitter that connects two electronic switches to four nodes.

### DETAILED DESCRIPTION

Waveguide array optical power splitters that provide compact, low-cost implementation of optical power splitting for one and two dimensional optical waveguide arrays are disclosed. The optical power splitters described herein do not introduce mode dependent loss and substantially preserve polarization, enabling the optical power splitters to be used with multimode and single mode light sources. In the following description, the term “light” refers to electromagnetic radiation over a broad range of wavelengths, including the ultraviolet, visible, and infrared portions of the electromagnetic spectrum.

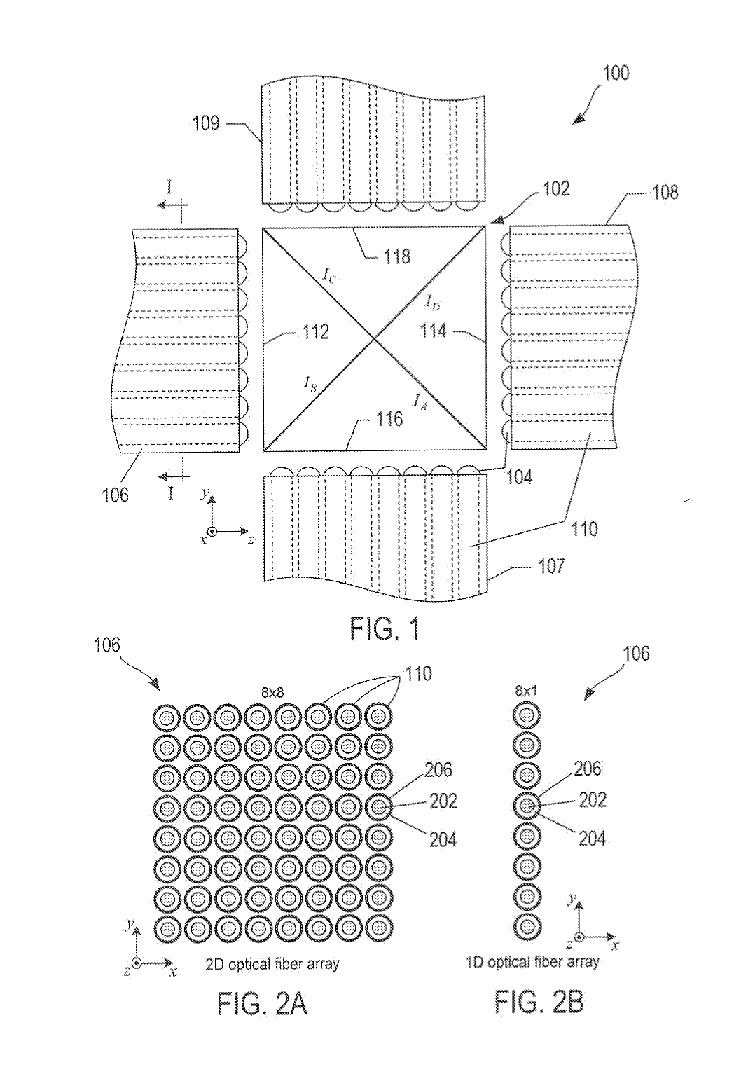

FIG. 1 shows a side elevation view of an example optical power splitter 100. The splitter 100 includes a beamsplitter 102 and a plurality of lenses 104. In the example of FIG. 1, each lens 104 is a plano-convex lens with the planar surface attached to the end of a waveguide using a transparent liquid adhesive or a transparent adhesive film. The waveguides are embedded in waveguide arrays 106-109. For example, lenses 104 are attached to the ends of waveguides 110 embedded in waveguide arrays 107 and 108. Alternatively, the lenses 104 can be biconvex lenses (not shown) with each lens attached to the end of a waveguide using a transparent liquid adhesive or a transparent adhesive film. Waveguide arrays 106 and 108 face opposing, parallel surfaces 112 and 114, respectively, and waveguide arrays 107 and 109 face opposing, parallel surfaces 116 and 118, respectively.

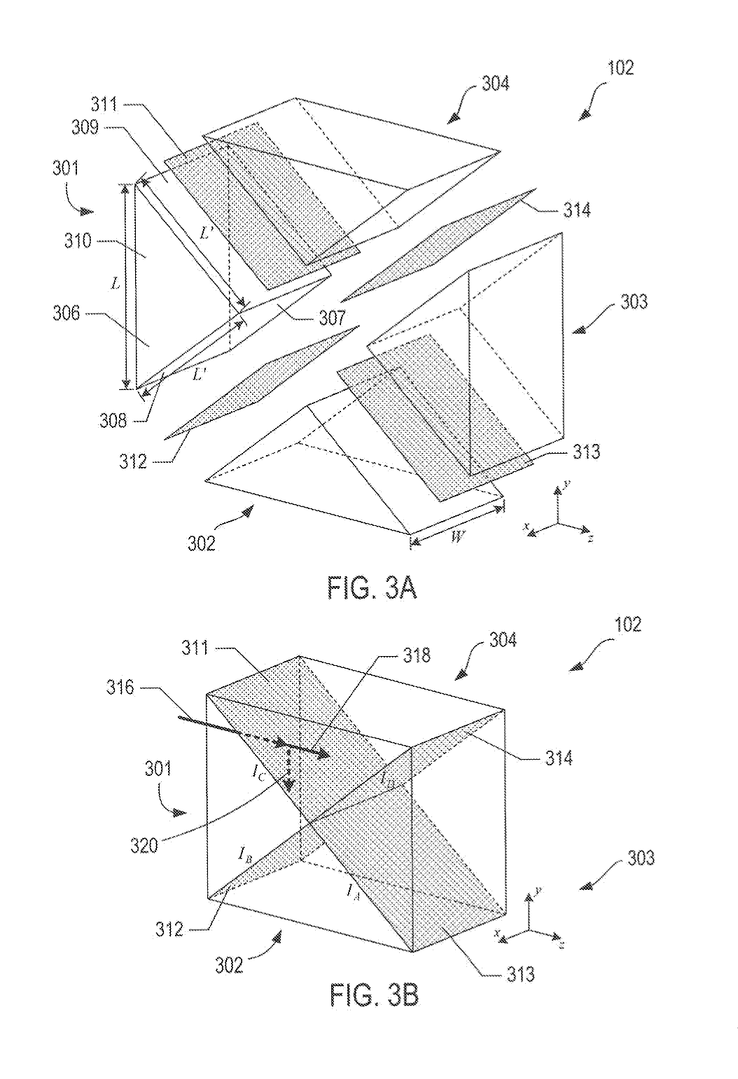

The waveguide arrays 106-109 can be two-dimensional or one-dimensional waveguide arrays, and the waveguides can be single or multimode optical fibers, an integrated planar waveguide, or a hollow metal waveguide. FIG. 2A shows a cross-sectional view along a line I-I, shown in FIG. 1, of the waveguide array 106 composed of a two-dimensional, square unit cell arrangement of 64 optical fibers 110. The array 106 can be called an 8×8 fiber array. FIG. 2B shows a cross-sectional view along the line I-I of the waveguide array 106 composed of a one-dimensional arrangement of eight optical fibers. The array 106 in this case can be called an 8×1 fiber array. In the examples of FIGS. 2A-2B, each optical fiber 110 includes a core 202 surrounded by a higher refractive index cladding layer 204, which is embedded within a plastic jacket 206. The fibers 110 can be bundled together with an adhesive or a jacket. The waveguide arrays 106-109 are not limited to the square or linear arrangements of optical fibers shown in FIGS. 2A-2B. Alternatively, the waveguides arrays can be M×N waveguides, where M and N are positive integers, and the two-dimensional waveguide arrays can have triangular, rhombic or any other suitable unit cell arrangement.

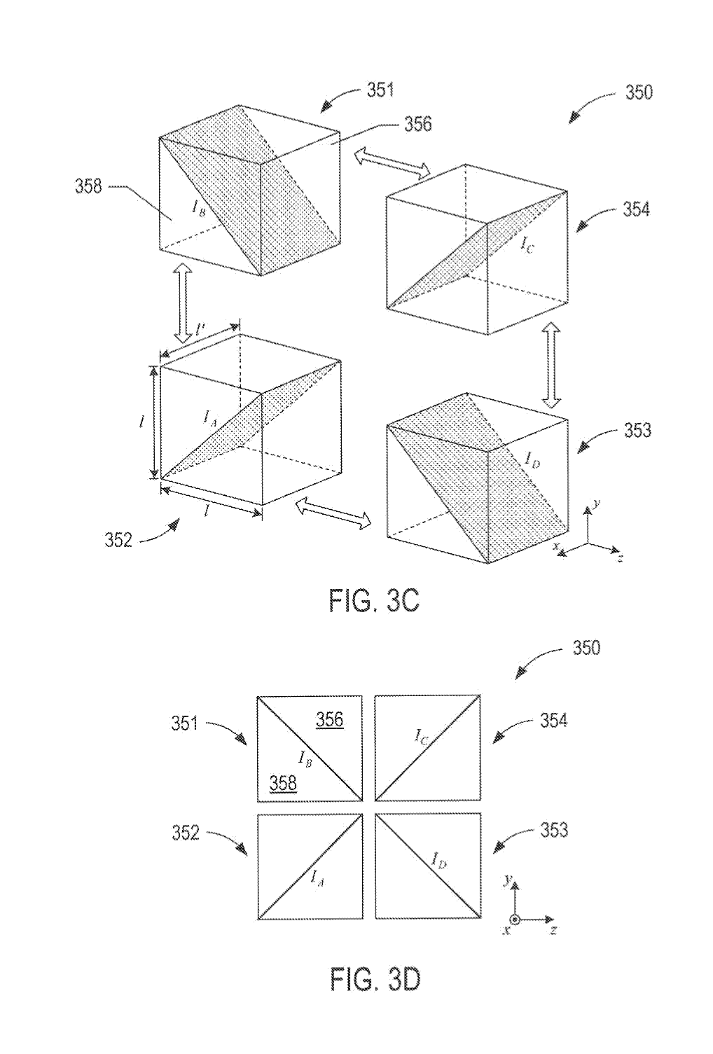

FIGS. 3A-3B show exploded and isometric views, respectively, of the beamsplitter 102. The beamsplitter 102 includes four separate triangular prisms 301-304. The prisms 301-304 can be composed of glass, plastic, or a polymer. Each prism is an isosceles triangular prism with two opposing end faces, two internal rectangular surfaces, and one outside rectangular surface. For example, the prism 301 has two opposing end faces 306 and 307, internal rectangular surface 308 and 309 and an outside rectangular surface 310. The end faces 306 and 307 are isosceles triangles that share edges of length L′ with the internal rectangular surfaces 308 and 309 and share edges of length L with the outside rectangular surface 310. The prisms 301-304 can be right-angle prisms in which the internal rectangular surfaces of the prisms 301-304 have the same edge length L′, the outside rectangular surfaces have the same edge length L, and the angle between internal rectangular surfaces of each prism is approximately 90°. As a result, the beamsplitter 102 has square opposing sides formed by the triangular surfaces of the prisms 301-304.

As shown in FIGS. 3A-3B, the beamsplitter 102 includes partially reflective films 311-314 disposed between the internal rectangular surfaces of the prisms 301-304. Each film forms a low-loss beam splitting interface between adjacent internal surfaces of any two prisms with a transmittance and reflectance determined by the composition and thickness of the film material. The beam splitting interfaces are identified in FIGS. 1 and 3B, and in subsequent figures, by I_{A}, I_{B}, I_{C} and I_{D}. For example, the films 311-314 can be thin, low-loss dielectric layers composed of different types of glass, each layer with a different index of refraction. Each film is substantially non-polarizing and does not introduce mode dependent loss in reflected and transmitted light. For example, as shown in FIG. 3B, an incident beam of light 316 passes through the prism 301 and interacts with the film 311 at interface I_{C}, the beam is split into a transmitted beam 318 and a reflected beam 320. If the incident beam 316 is partially polarized, the transmitted and reflected beams 318 and 320 have substantially the same polarization as the incident beam 316. The transmitted and reflected beams 318 and 320 also have the same transverse modes as the beam 316. In other words, the film 311 at the interface I_{C} does not introduce mode dependent loss.

Although, for the sake of brevity, various embodiments for implementing optical beam splitters are described below with reference to splitter 102, optical beam splitters are not intended to be limited to the beamsplitter 102 configuration. FIGS. 3C-3D show exploded and isometric views, respectively, of a beamsplitter 350. The beamsplitter 350 includes four separate rectangular beamsplitter prisms 351-354. Each beamsplitter prism includes two right triangular prisms with a partially reflective film disposed between the hypotenuse faces of the prisms. For example, beamsplitter prism 351 includes right triangular prisms 356 and 358 with partially reflective film at interface I_{B} disposed between the hypotenuse faces of the prisms. The triangular prisms of each beamsplitter prism can be composed of glass, plastic, or a polymer. Each film forms a low-loss beam splitting interface between adjacent hypotenuse faces with a transmittance and reflectance determined by the composition and thickness of the film material. The beam splitting interfaces are also identified by I_{A}, I_{B}, I_{C} and I_{D} and have the same optical properties as the beam splitting interfaces described below with reference to the splitter 102.

FIG. 3E shows an isometric view of a beamsplitter 380. The beamsplitter 380 includes four separate rectangular plates 381-384 positioned at approximately 90° to one another. The plates 381-384 can be composed of glass, dielectric layers, semiconductors, plastics, or polymers, such as poly(methyl methacrylate) (“PMMA”). Each plate is a low-loss beam splitting interface with a transmittance and reflectance determined by the composition and thickness of the plate material. The beam splitting interfaces are also identified by I_{A}, I_{B}, I_{C} and I_{D} and have the same optical properties as the beam splitting interfaces described below with reference to the splitter 102. The plates 381-384 can be arranged to compensate for spatial beam walk-off (i.e., Poynting vector walk-off) due to the finite thickness of the plates. Alternatively, pellicle beamsplitters may be used in place of the plates 381-384, in which case, beam walk-off is reduced or eliminated.

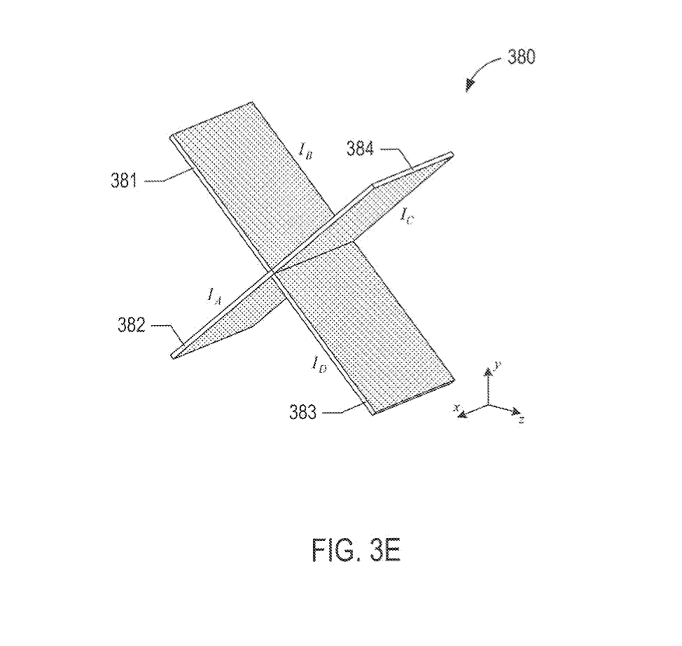

The transverse modes preserved by the beamsplitter 102 are denoted by TEMₘ, where the m is a non-negative integer that represents the number of transverse nodal lines across the beam of light transmitted in the waveguides and the beamsplitter 102. FIGS. 4A-4C show three separate examples of transverse modes of light carried by an optical fiber 400. The fiber 400 includes a core 402 and an outer cladding layer 404. In FIG. 4A, the lowest order transverse mode TEM₀ has no nodal lines and is characterized by a symmetric Gaussian distribution 406 in which most of the light in this mode is concentrated near the center of the core 402. In FIG. 4B, the transverse mode TEM₁ has one nodal line 408 in which the light is concentrated in two separate regions 410 and 412 of the core 402 as the light transits the fiber 400. The distribution of light over the regions 410 and 412 is characterized in the x-direction by a distribution 414. In FIG. 4C, the transverse mode TEM₂ has two nodal lines 418 and 420 in which the light is concentrated in three separate regions of the core 402 as the light transits the fiber 400. The distribution of light over the three regions is characterized in the x-direction by a distribution 422.

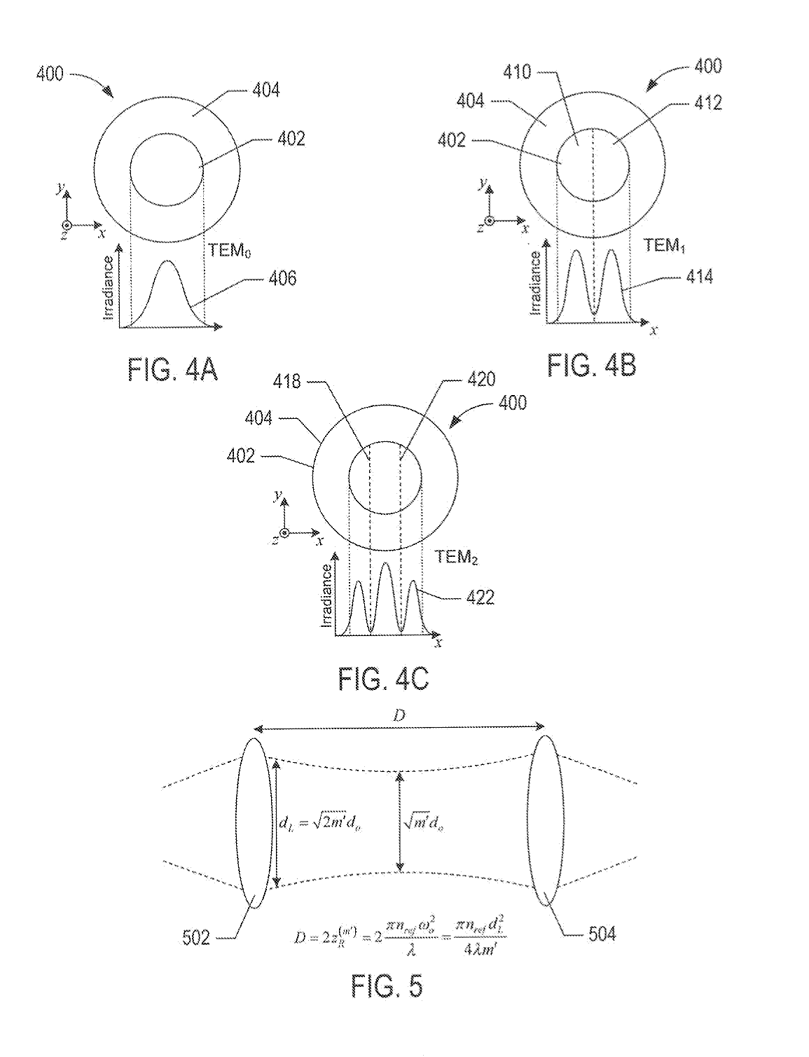

The maximum spacing between lenses facing opposing surfaces of the beamsplitter 102 depends on the optical diffraction. FIG. 5 shows two opposing lenses 502 and 504 of an optical power splitter. The lenses 502 and 504 face opposing, parallel outer surfaces of a beamsplitter (not shown) of an optical power splitter. The maximum distance separating opposing lenses 502 and 504 can be determined by:

$$D = \frac{π {n}_{ref} {d}_{L}^{2}}{4 λ {m}^{′}}$$

where n_{ref} is the refractive index of the beamsplitter prisms,

d_{L} is the diameter of the lenses 502 and 504 or the optical diameter of the beam at the lenses 502 and 504,

λ is the wavelength of the light, and

m′=m+1.

In other words, the distance separating opposing lenses 502 and 504 is limited by the number of modes carried by a multimode waveguide and the waveguide spacing in the waveguide arrays. Table 1 represents how the distance D changes as a function of the modes m′ for n_{ref}=1.5, λ=850 nm, and d_{L}=181 μm:

TABLE 1

| m′ | D(mm) |
|---|---|
| 1 | 45 |
| 4 | 11 |
| 5 | 9 |
| 6 | 7.5 |
| 18 | 2.5 |

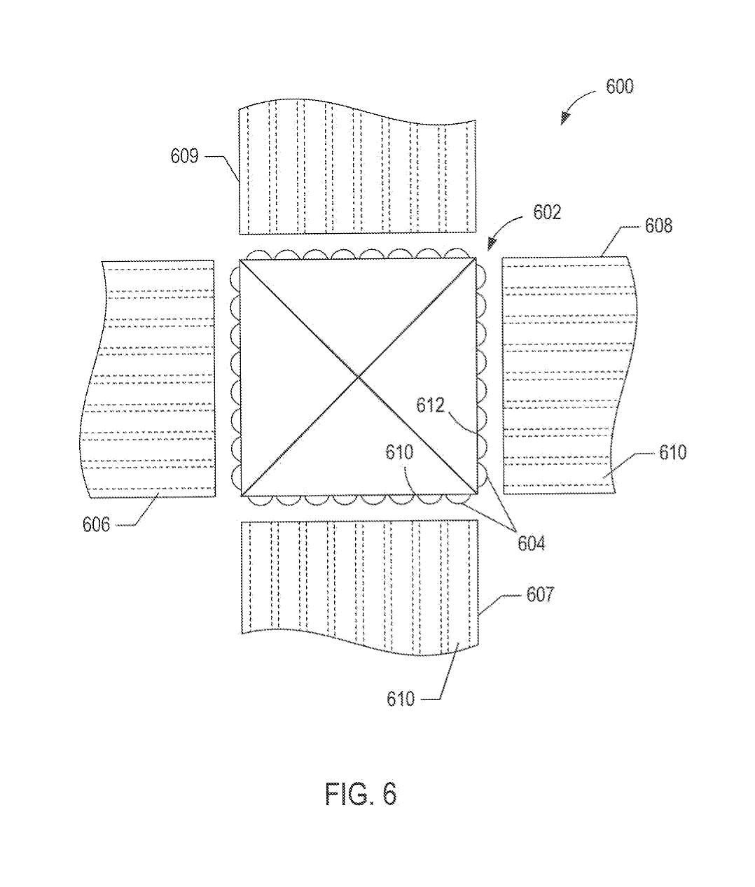

Optical power splitters are not limited to the lenses being attached to the ends of the waveguides in the waveguide arrays, as shown in FIG. 1. Alternatively, the lenses can be attached to the outer surfaces of the beamsplitter. FIG. 6 shows a side elevation view of an example optical power splitter 600. The splitter 600 includes a beamsplitter 602 and a plurality of lenses 604. In the example of FIG. 6, the lenses 604 are plano-convex lenses with the convex surface of each lens extending from the beamsplitter 602. The lenses 604 can be formed by molding the lenses into the outside rectangular surfaces of the prisms, or the lenses 604 can be attached using a transparent liquid adhesive or a transparent adhesive film. The waveguides of waveguide arrays 606-609 are aligned with the lenses 604. For example, lenses 604 are aligned with waveguides 610 of waveguide arrays 607 and 608. Male and female alignment features (not shown) can be used to passively align the waveguides with the lenses.

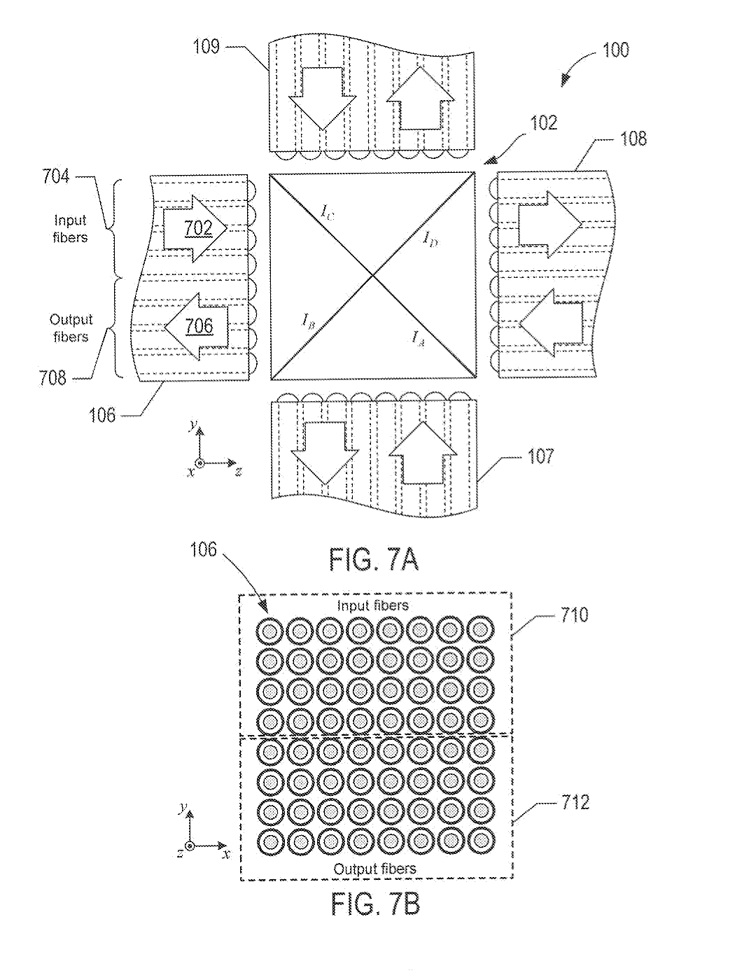

The splitters 100 and 600 are operated by dedicating a portion of the waveguides within each waveguide array to input light to the beamsplitters 102 and 606 and dedicating the remaining portion of the waveguides within each waveguide array to receive light output from the beamsplitters 102 and 606. FIG. 7A shows an example of the waveguides in the waveguide arrays 106-109 dedicated to input light to and receive light output from the splitter 100. Directional arrows indicate the input and output directions light travels in the waveguides of the waveguide arrays 106-109. For example, directional arrow 702 represents light transmitted into the splitter 100 in the fibers 704 of waveguide array 106, and directional arrow 706 represents light transmitted out of the splitter 100 in the fibers 708 of the waveguide array 106. FIG. 7B shows an end-on view of the example 8×8 two-dimensional waveguide array 106 shown in FIG. 2A. The four rows of optical fibers outlined by enclosure 710 are used to input light to the splitter 100, and the four rows of optical fibers outlined by enclosure 712 receive beams of light output from the splitter 100. The splitter 100 has four input ports and four output ports and can be called a 4×4 optical power splitter.

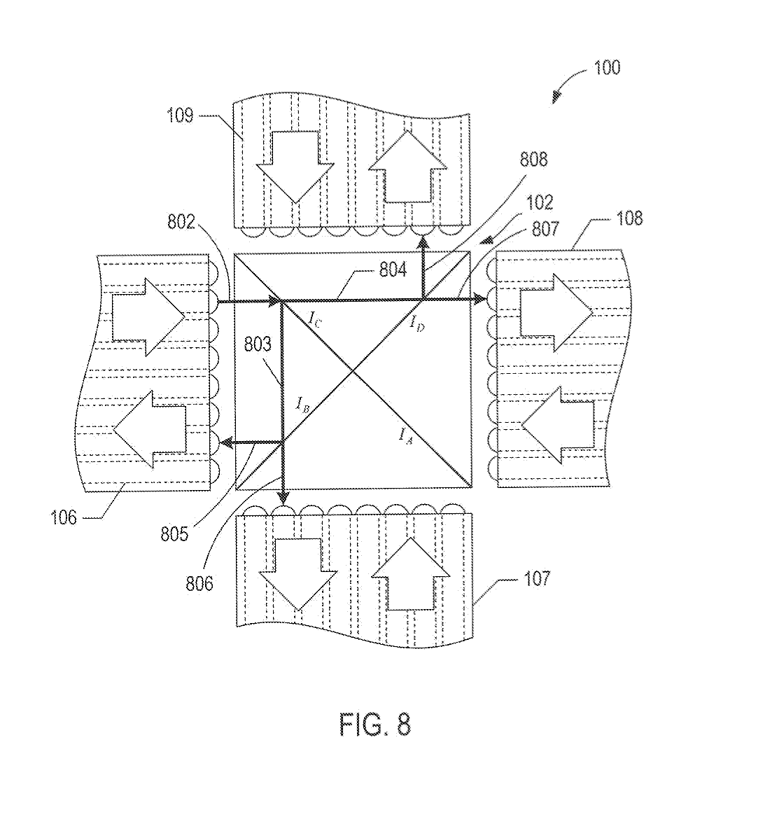

FIG. 8 shows an example of reflected and transmitted paths of light input to the splitter 100. For the sake of simplicity, the path each beam takes through the beam splitter 102 is represented by a vector or a ray. The interfaces I_{A}, I_{B}, I_{C} and I_{D} include film materials and layers that split an incident beam into a transmitted beam and a reflected beam with the optical power represented by:

P_{incident}=P_{R}+P_{T}+Pₗₒₛₛ

where

P_{incident} represents the optical power of a beam of light striking an interface film,

P_{R} represents the optical power of the reflected beam,

P_{T} represents the optical power of the transmitted beam, and

Pₗₒₛₛ represents the optical power lost due to the film and the prism.

As shown in FIG. 8, light is output from a waveguide and substantially collimated by an associated lens into a beam 802 that enters the beamsplitter 102. The beam 802 is split at the interface I_{C} into a reflected beam 803 and a transmitted beam 804. The reflected beam 803 is split at the interface I_{B} into a first reflected beam 805 and a first transmitted beam 806, and the transmitted beam 804 is split at the interface I_{D} into a second transmitted beam 807 and a second reflected beam 808. The beams 805-808 exit the outer rectangular surfaces of the beamsplitter 102 and are each focused by a lens into one waveguide of the waveguide arrays 106-109, respectively.

In the example of FIG. 8, the beamsplitter 102 can be a 50:50 beamsplitter, in which case, each interface splits an incident beam into reflected and transmitted beams with approximately the same optical power (i.e., P_{R}≈P_{T}). As a result, each of the beams 805-808 is emitted with approximately 25% of P_{incident}. Alternatively, the reflectance and transmittance of the interfaces can be selected to output light into the waveguides of the waveguide arrays with desired optical powers. For example, suppose light input to the waveguides of the waveguide array 108 has a longer distance to travel to reach a first destination than the light input to the waveguides of the waveguide array 109 has to travel to reach a second destination. If the optical power of the light entering the waveguides of the waveguide arrays 108 and 109 is the same, the light that reaches the first destination is more attenuated than the light that reaches the second destination. As a result, it may be desirable to selectively configure the interfaces of the beamsplitter 102 so that the light input to the waveguides of the waveguide array 108 has more optical power than the light input to the waveguides of the waveguide array 109. In other words, it may be desirable to configure the interfaces of the beamsplitter 102 to input light to the waveguides of certain waveguide arrays with more or less optical power.

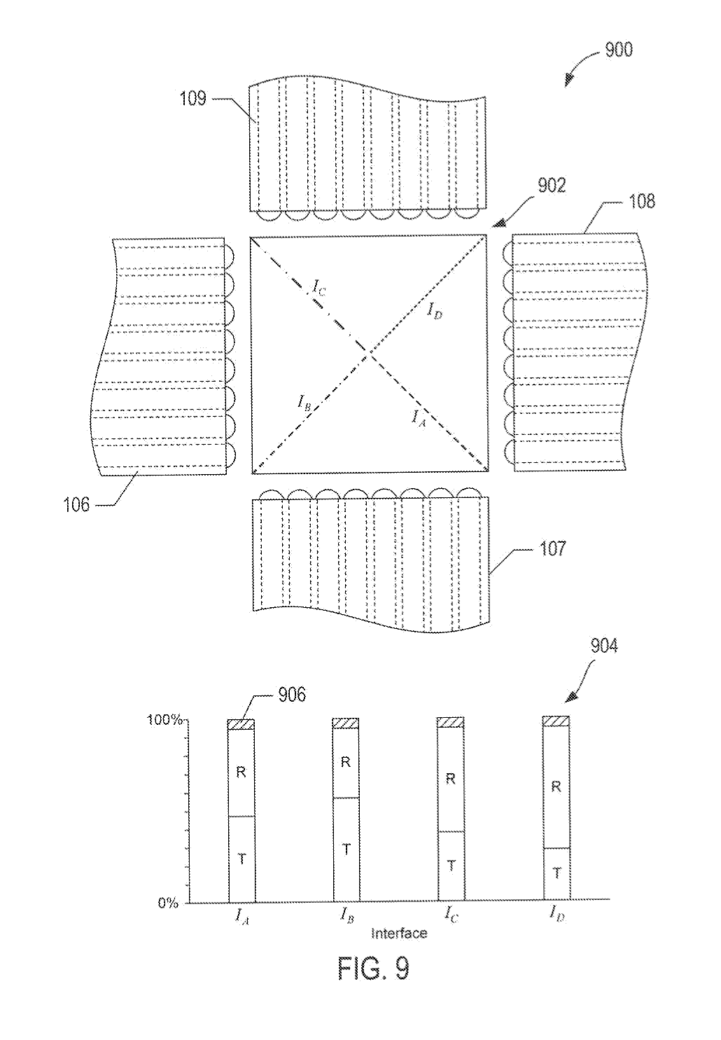

FIG. 9 shows an example optical power splitter 900 with a beamsplitter 902 configured to output light into the fibers arrays 106-109, each fiber receiving light with a different optical power. Each interface is identified by a different line pattern that represents the different reflectance and transmittance of the interfaces. FIG. 9 includes a bar graph 904 that represents an example reflectance “R” and transmittance “T” for each of the interfaces. Shaded portions, such as portion 906, of each bar represent the percentage of optical loss associated with each interface. In the example of FIG. 9, the interfaces each have an optical loss of approximately 8%. The bar graph 906 indicates that the interfaces I_{A}, I_{B}, I_{C}, and I_{D} each have a different reflectance and transmittance as indicated by the different lengths in the R and T segments of each bar. For example, the interface I_{A} operates as a 50:50 beamsplitter with a reflectance and a transmittance of approximately 46%, while the interface I_{B} operates as a 60:40 beamsplitter with a reflectance of approximately 38% and a transmittance of approximately 54%.

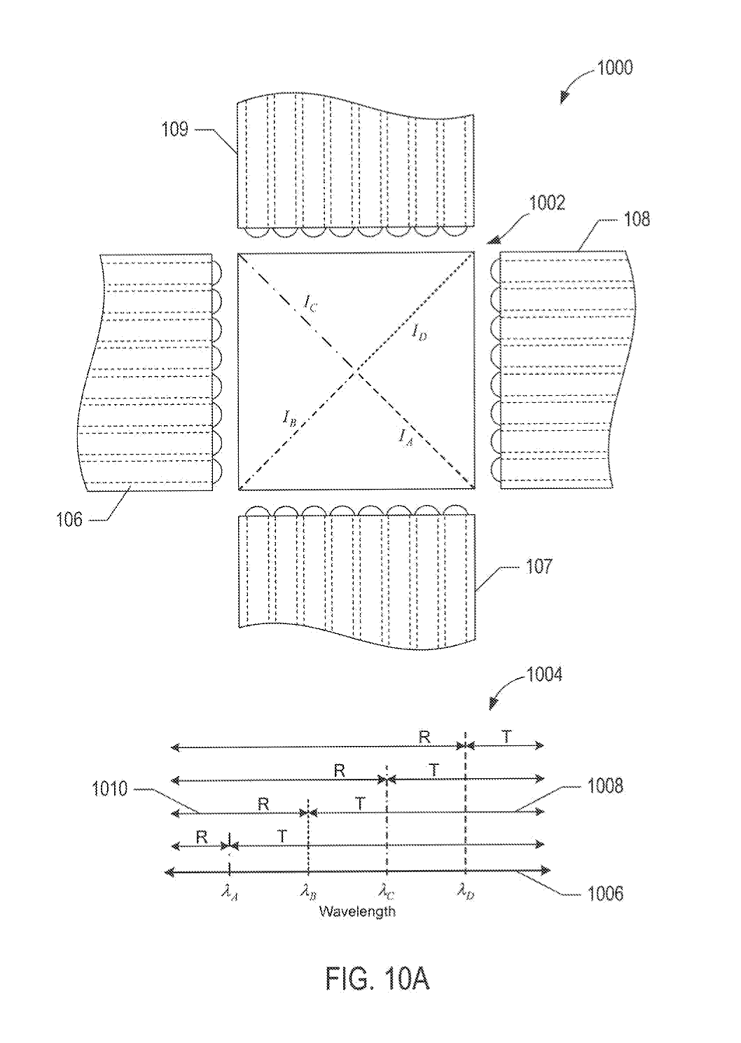

Optical power splitters can also be configured to split (or combine) light according to the wavelength of the light input to the splitters. FIG. 10A shows an example optical power splitter 1000 configured to output light into the waveguide arrays 106-109 based on the wavelength of the light. FIG. 10A includes a plot 1004 that represents an example reflectance and transmittance of the interfaces based on the wavelength of the light. In the plot 1004, threshold wavelengths associated with the interfaces I_{A}, I_{B}, I_{C}, and I_{D} are plotted along a wavelength axis 1006 and are identified by λ_{A}, λ_{B}, λ_{C}, and λ_{D}, respectively. In the example of FIG. 10, each interface transmits light with a wavelength greater than the associated threshold wavelength and reflects light with a wavelength smaller than the associated threshold wavelength. For example, plot 1004 reveals that the interface I_{B} transmits 1008 wavelengths greater than λ_{B} and reflects 1010 wavelengths less than λ_{B}.

FIG. 10B shows an example of the splitter 1000 in operation. Light composed of four distinct wavelengths λ₁, λ₂, λ₃, and λ₄ is output from a waveguide of the waveguide array 106 and substantially collimated by an associated lens into a beam 1010 that enters the beamsplitter 1002. The example wavelengths λ₁, λ₂, λ₃, and λ₄ are plotted on the wavelength axis 1006 of the plot 1004. The beam 1010 is split at the interface I_{C} into a reflected beam 1011 of wavelengths λ₃ and λ₄ and a transmitted beam 1012 of wavelengths λ₁ and λ₂. The reflected beam 1011 is split at the interface I_{B} into a transmitted beam 1013 of wavelength λ₃ and a reflected beam 1014 of wavelength λ₄, and the transmitted beam 1012 is split at the interface I_{D} into a transmitted beam 1015 of wavelength λ₁ and a reflected beam 1016 of wavelength λ₂. The beams 1013-1016 exit the outer rectangular surfaces of the beamsplitter 102 and are each focused by a lens into one waveguide of the waveguide arrays 106-109, respectively.

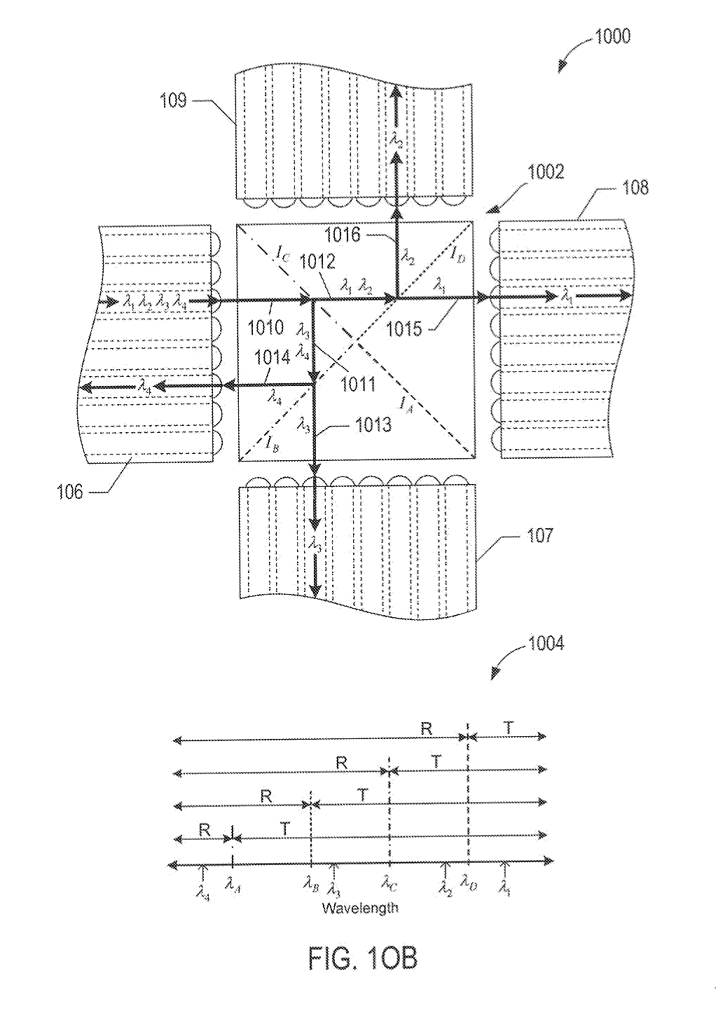

Optical power splitters are not limited to a four prism beamsplitter as described above. FIG. 11 shows a side elevation view of an example optical power splitter 1100. The splitter 1100 is similar to the splitter 100 with the beamsplitter replaced by a beamsplitter 1102. The beamsplitter 1102 is composed of two prisms 1104 and 1106 with a single interface 1108 composed of thin film of low-loss dielectric layers of different types of glass, each layer with a different index of refraction. The interface is non-polarizing and does not introduce mode dependent loss in reflected and transmitted light. Unlike the splitters described above, the entire set of waveguides in a waveguide array are used to either input light to or output light from the splitter 1100. The splitter 1100 has two input ports (i.e., waveguide arrays 106 and 109) and two output ports (i.e., waveguide arrays 107 and 108) and can be referred to as a 2×2 optical power splitter.

Optical power splitters can be used to optically connect computing devices. Consider, for example, a rack mounted computing system composed of a number of nodes, such as blades or line cards. The system includes a chassis that can hold multiple nodes, provide services such as power, cooling, networking, various interconnects and node management. Each node can be composed of at least one processor, memory, integrated network controllers, and other input/output ports, and each node may include local drives and can connect to a storage pool facilitated by a network-attached storage, Fiber Channel, or iSCSI storage-area network. Certain nodes within the system can be connected to one another via optical power splitters and waveguides, enabling each node to send a high volume of data encoded in optical signals to other nodes in the system. An optical signal encodes information in high and low amplitude states or phase changes of a channel of electromagnetic radiation. A “channel” can be a single wavelength of electromagnetic radiation or a band of electromagnetic radiation centered about a particular wavelength. For example, each high amplitude portion of an optical signal can represent a logic bit value “1” and each low amplitude portion of the same optical signal can represent a logic bit value “0,” or vice versa. The optical signal can be transmitted over a waveguide, such as a waveguide, or though free space.

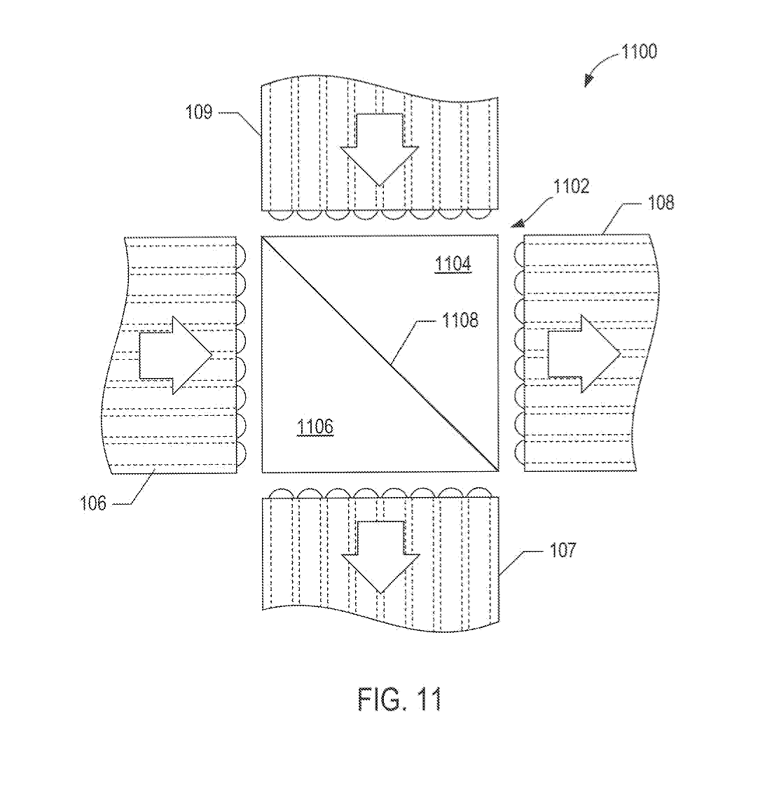

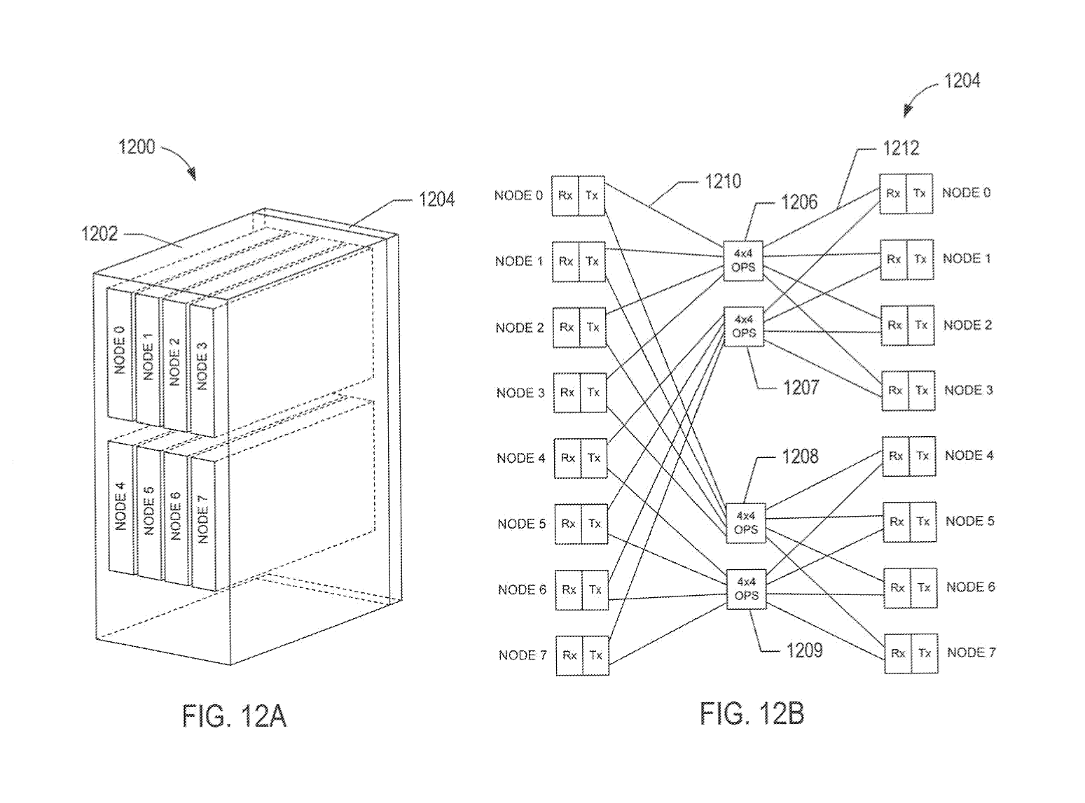

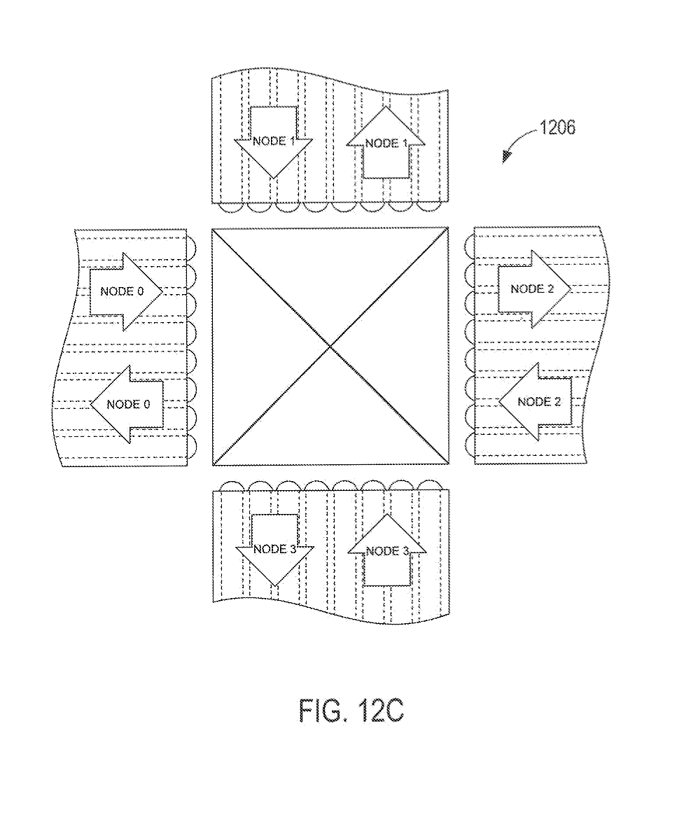

FIG. 12A shows an isometric view of an example rack mounted system 1200 composed of eight nodes mounted in an enclosure or chassis 1202. Each node is connected to a backplane 1204 that includes optical power splitters to provide optical input/output connectivity between the nodes. FIG. 12B shows a schematic representation of four 4×4 optical power splitters 1206-1209 that form a star optical bus to optically connect the nodes. Each node includes a receiver denoted by “Rx” and a transmitter denoted by “Tx.” Each receiver includes a number of photodetectors and amplifiers to receive and convert optical signals into electric signals for processing at the node. Each transmitter includes a number of light emitters, such as vertical-cavity surface-emitting lasers or edge-emitting lasers, that may be directly modulated to convert electric signals generated by a node into optical signals. Alternatively, each transmitter can include external modulators that modulate the light emitted by the light emitters. In the example of FIG. 12B, each splitter is connected by four waveguide arrays to four nodes. A line connecting a transmitter Tx to an splitter represents the waveguides of waveguide array that are dedicated to transmitting optical signals into the splitter, and a line connecting a receiver Rx to a splitter represents the waveguides of the waveguide array that are dedicated to receiving optical signals from the splitter. For example, line 1210 represents waveguides of a waveguide array dedicated to transmitting optical signals from node 0 to the splitter 1206, and line 1212 represents waveguides of the same waveguide array dedicated to sending optical signals from the splitter 1206 to node 0. FIG. 12C shows an example of how waveguides of four waveguide arrays connected to the splitter 1206 are dedicated to send optical signals to and from the nodes 0, 1, 2, and 3 via the splitter 1206.

Returning to FIG. 12B, each receiver Rx (or transmitter Tx) may have an associated buffer to temporarily store information sent to the node (or waiting to be transmitted by a node). The collective buffers of the nodes can be used to form virtual buffer storage when the buffer of at least one receiving node (or transmitting node) is full. In certain embodiments, the system 1200 can include a control (not shown) that controls which node is allowed to use the backplane 1204 to send optical signals to the other nodes in the system, or each node can use in-band signaling that includes control information regarding which node can use the optical bus to send optical signals. For example, suppose the buffer of node 1 is full, but it is node 2's turn to send optical signals over the backplane 1204 and certain optical signals identify node 1 as the recipient. The controller directs node 2 to send the optical signals intended for node 1 to node 3 and directs node 3 to temporarily store the information intended for node 1 until it is node 3's turn to use the backplane 1204. The optical signals intended for node 1 are sent to the splitter 1206, which, in turn, forwards the optical signals to the nodes 0-3. The nodes 0, 1, and 2 discard the optical signals because node 3 is identified in the headers of the optical signal packets as the intended recipient. When it is node 3's turn to use the backplane 1204 to send optical signals to the other nodes, node 3 sends optical signals encoding the information node 2 intended to send to node 1 but were temporarily stored in node 3's buffer.

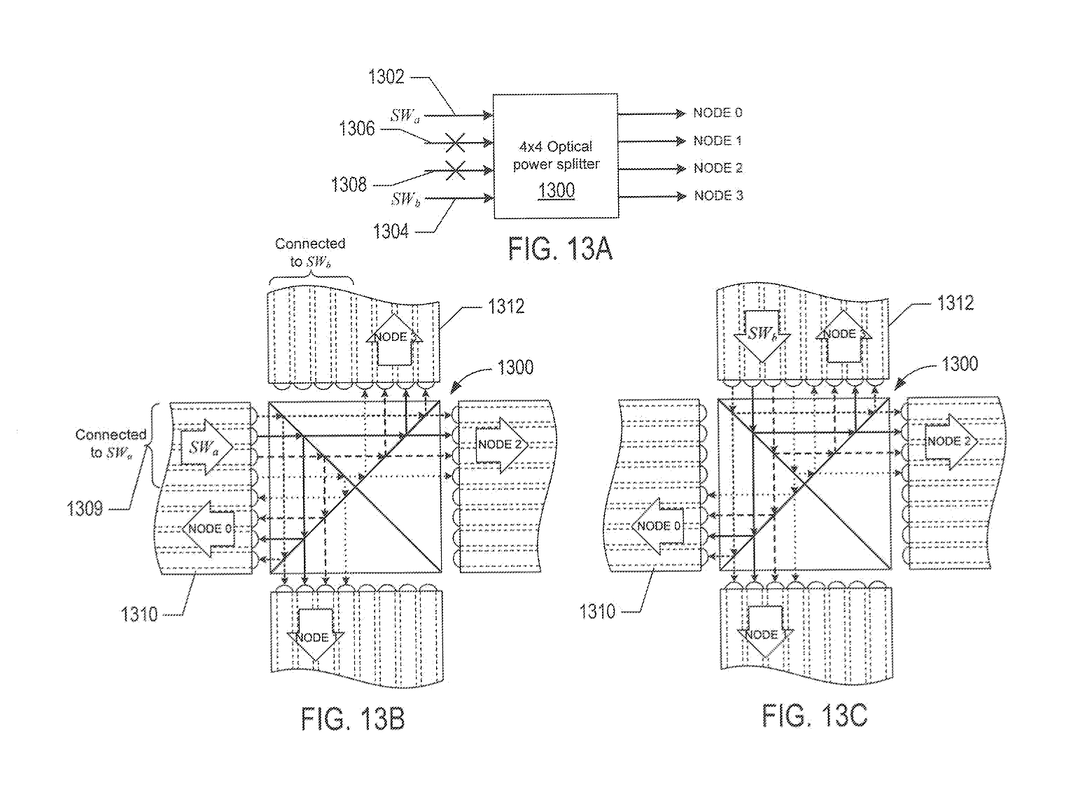

Optical power splitters can be integrated with electronic switches in the backplane of a computer system. FIG. 13A shows an example schematic representation of a 4×4 optical power splitter 1300 that connects two electronic switches SWₐ and SW_{b} to four nodes. The switch SWₐ is the active switch, while the switch SW_{b} is the back-up or redundant switch to be used when the active switch SWₐ fails. The switch SWₐ is connected to a first input port 1302 of the splitter 1300, and the switch SW_{b} is connected to a second input port 1304 of the splitter 1300. The two remaining input ports 1306 and 1308 are not used. FIGS. 13B-13C show the splitter 1300 connected to switches SWₐ and SW_{b} and the four nodes. In the example of FIG. 13B, waveguides 1309 of waveguide array 1310 carry optical signals, represented by directional arrows, from the switch SWₐ to the splitter 1300. The optical signals are output from the splitter 1300 to the four nodes. In the example of FIG. 13C, the switch SWₐ has failed and waveguides 1311 of waveguide array 1312 are used to carry the same optical signals from the switch SW_{b} to the splitter 1300 with the optical signals output into the same waveguides as the optical signals sent from the switch SWₐ shown in FIG. 13B.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. An optical power splitter comprising:
a beamsplitter to receive a plurality of incident beams of light, the beamsplitter to split each incident beam of light into a plurality of output beams of light, each output beam to be output in a different direction from the beamsplitter;
a first set of lenses, each lens in the first set to approximately collimate one of the incident beams of light to be input to the beamsplitter; and
a second set of lenses, each lens in the second set to focus one of the output beams of light to be output from the beamsplitter.

2. The splitter of claim 1, wherein the beamsplitter comprises partially reflective films each of which forms a beam splitting interface, each beam splitting interface to split an incident beam of light into a first beam of light and a second beam of light.

3. The splitter of claim 2, wherein each beam splitting interface to split the incident beam of light into the first beam of light and the second beam of light further comprises a beam splitting interface to split the incident beam of light so that the first and second output beams have the same transverse modes and substantially the same polarization as the incident beam.

4. The splitter of claim 2, wherein each beam splitting interface further comprises a wavelength dependant beam splitting interface, wherein the first output beam wavelengths are different from the second output beam wavelengths.

5. The splitter of claim 2, wherein each beam splitting interface further comprises the beam splitting interface to split the incident beam of light so that the first and second output beams have approximately the same optical power.

6. The splitter of claim 2, wherein each beam splitting interface further comprise the beam splitting interface to split the incident beam of light so that the first and second output beams have different optical powers.

7. The splitter of claim 1, wherein the sets of focusing lenses are attached to the ends of waveguides.

8. A multi-node computer system comprising:
an optical power splitter; and
waveguide arrays, each waveguide array optically coupled at a first end to the optical power splitter and optically coupled at a second end to a node, the optical power splitter to receive incident optical signals from the node via waveguides of a waveguide array, the optical power splitter to split each incident optical signal into a plurality of optical signals, each optical signal to be input to one waveguide of each waveguide array.

9. The system of claim 8, wherein the optical power splitter comprises:
a beamsplitter to receive the incident optical signals and split each incident optical signal into the plurality of optical signals, each optical signal to be output in a different direction from the beamsplitter;
a first set of lenses, each lens in the first set to approximately collimate one of the incident optical signals to be input to the beamsplitter; and
a second set of lenses, each lens in the second set to focus one of the optical signals to be output from the beamsplitter.

10. The system of claim 9, wherein the beamsplitter comprises partially reflective films each of which forms a beam splitting interfaces, each beam splitting interface to split an optical signal into a first optical signal and a second optical signal.

11. The system of claim 10, wherein each beam splitting interface to split the optical signal into the first optical signal and the second optical further comprises each beam splitting interface to split the optical signal so that the first and second optical signals have the same transverse modes and polarization as the optical signal.

12. The system of claim 10, wherein each beam splitting interface further comprises a wavelength dependant beam splitting interface, wherein the first optical signal wavelengths are different from the second optical signal wavelengths.

13. The system of claim 10, wherein each beam splitting interface further comprises the beam splitting interface to split the incident beam of light so that the first and second optical signals have different optical powers.

14. The system of claim 8 further comprises a control to arbitrate which node in the multi-node system has permission to send information in optical signals over the optical power splitter.

15. The system of claim 8, wherein waveguide arrays further comprise at least one multimode waveguide.
